(19) United States
(12) Patent Application Publication
(10) Pub. No.: US 2005/0025467 A1
(43) Pub. Date: Feb. 3, 2005

(54) Recording and reproducing apparatus

(76) Inventors: Yoshiyuki Nakamichi, Hirakata City (JP); Haruhiko Yoneda, Minoh City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/883,967

(22) Filed: Jul. 6, 2004

(30) Foreign Application Priority Data
Jul. 8, 2003 (JP) 2003-193283

(51) Int. Cl. H04N 5/781; G11B 5/00

(52) U.S. Cl. 386/125; 360/7

(57) ABSTRACT

A recording and reproducing apparatus comprises the function of continuing, when a normal recording start command is inputted during full-time recording and time shift reproduction, the full-time recording as well as transferring to a normal recording area data from a time shift reproduction position, at the time that the normal recording start command is inputted, in a full-time recording area to a recording point on the full-time recording area at the time point where a normal recording stop command is inputted.

### BACKGROUND OF THE INVENTION

1. Field of the Invention

The present invention relates to a recording and reproducing apparatus such as an HDD (Hard Disk Drive) recorder or a DVD (Digital Versatile Disk) recorder.

2. Description of the Background Art

Examples of HDD recorders include ones comprising the function of performing full-time recording using a ring buffer and a time shift reproduction function for reproducing video/audio data recorded all the times from an address which is the same as or different from a recording address.

Developed as this type of HDD recorder is one so adapted that a full-time recording operation and a time shift reproduction operation are stopped when normal recording is started during full-time recording and time shift reproduction, to start the normal recording in real time from the time point, and a user is caused to choose whether or not data recorded by the full-time recording so far performed is separately stored, to separately store the data recorded by the full-time recording so far performed when it is chosen that the recorded data is stored (hereinafter referred to as a first conventional example).

An HDD recorder comprising the functions of stopping a full-time recording operation and a time shift reproduction operation when normal recording is started during full-time recording and time shift reproduction, to start the normal recording in real time from the time point, and automatically coupling data recorded by the full-time recording before the normal recording and data recorded by the normal recording performed after that to form one file has been also developed (hereinafter referred to as a second conventional example; see JP-A-2003-299007).

An HDD recorder comprising the functions of stopping a full-time recording operation and a time shift reproduction operation when normal recording is started during full-time recording and time shift reproduction, to start the normal recording as well as automatically copying on a normal recording-area data recorded by the full-time recording from a position where time shift reproduction is performed (hereinafter referred to as a time shift reproduction position) to a position where normal recording is started (hereinafter referred to as a normal recording start position) has been also developed (hereinafter referred to as a third conventional example; see JP-A-2002-142177).

In the first conventional example, the data recorded by the full-time recording and the data recorded by the normal recording performed after that are separately stored in different files.

In the second and third conventional examples, the data recorded by the full-time recording and the data recorded by the normal recording performed after that can be stored as one file. When the normal recording is started, however, the full-time recording operation is stopped, so that time shift reproduction for the normal recording cannot be performed.

### SUMMARY OF THE INVENTION

An object of the present invention is to provide a recording and reproducing apparatus capable of storing, when a normal recording start command is inputted during full-time recording and time shift reproduction, input data from a time shift reproduction position at the time point where the normal recording start command is inputted to a position where a normal recording stop command is inputted in a single file as well as capable of performing full-time recording and time shift reproduction for the full-time recording even after the normal recording start command is inputted.

Another object of the present invention is to provide a recording and reproducing apparatus capable of storing, when a normal recording start command is inputted during full-time recording, input data from a position designated by a user to a position where a normal recording stop command is inputted in a single file as well as capable of performing full-time recording and time shift reproduction for the full-time recording even after the normal recording start command is inputted.

A first recording and reproducing apparatus according to the present invention is characterized by comprising first means for continuing, when a normal recording start command is inputted during full-time recording and time shift reproduction, the full-time recording as well as starting data transfer from a time shift reproduction position, at the time that the normal recording start command is inputted, in a full-time recording area to a normal recording area; second means for judging, when a normal recording stop command is inputted in a case where the transfer by the first means is being performed, whether or not data to a recording point on the full-time recording area at the time point where the normal recording stop command is inputted is being transferred to the normal recording area; third means for stopping, when the second means judges that the data to the recording point on the full-time recording area at the time point where the normal recording stop command is inputted is not being transferred to the normal recording area, the data transfer after the data to the recording point on the full-time recording area at the time point where the normal recording stop command is inputted is transferred to the normal recording area; and fourth means for stopping, when the second means judges that the data to the recording point on the full-time recording area at the time point where the normal recording stop command is inputted is being transferred to the normal recording area, the data transfer.

A second recording and reproducing apparatus according to the present invention is characterized by comprising a first circuit for starting, when a normal recording start command is inputted during full-time recording and time shift reproduction, the full-time recording as well as starting data transfer from a time shift reproduction position, at the time that the normal recording start command is inputted, in a full-time recording area to a normal recording area; a second circuit for judging, when a normal recording stop command is inputted in a case where the transfer by the first circuit is being performed, whether or not data to a recording point on the full-time recording area at the time point where the normal recording stop command is inputted is being transferred to the normal recording area; a third circuit for stopping, when the second circuit judges that the data to the recording point on the full-time recording area at the time point where the normal recording stop command is inputted is not being transferred to the normal recording area, the data transfer after the data to the recording point on the full-time recording area at the time point where the normal recording stop command is inputted is transferred to the normal recording area; and a fourth circuit for stopping, when the second circuit judges that the data to the recording point on the full-time recording area at the time point where the normal recording stop command is inputted is being transferred to the normal recording area, the data transfer.

A third recording and reproducing apparatus according to the present invention is characterized by comprising input means for continuing, when a normal recording start command is inputted during full-time recording, the full-time recording as well as designating a data transfer start position in a full-time recording area; first means for starting data transfer from the data transfer start position in the full-time recording area designated by the input means to a normal recording area; second means for judging, when a normal recording stop command is inputted in a case where the transfer by the first means is being performed, whether or not data to a recording point on the full-time recording area at the time point where the normal recording stop command is inputted is being transferred to the normal recording area; third means for stopping, when the second means judges that the data to the recording point on the full-time recording area at the time point where the normal recording stop command is inputted is not being transferred to the normal recording area, the data transfer after the data to the recording point on the full-time recording area at the time point where the normal recording stop command is inputted is transferred to the normal recording area; and fourth means for stopping, when the second means judges that the data to the recording point on the full-time recording area at the time point where the normal recording stop command is inputted is being transferred to the normal recording area, the data transfer.

A fourth recording and reproducing apparatus according to the present invention is characterized by comprising an input circuit for continuing, when a normal recording start command is inputted during full-time recording, the full-time recording as well as designating a data transfer start position in a full-time recording area; a first circuit for starting data transfer from the data transfer start position in the full-time recording area designated by the input circuit to a normal recording area; a second circuit for judging, when a normal recording stop command is inputted in a case where the transfer by the first circuit is being performed, whether or not data to a recording point on the full-time recording area at the time point where the normal recording stop command is inputted is being transferred to the normal recording area; a third circuit for stopping, when the second circuit judges that the data to the recording point on the full-time recording area at the time point where the normal recording stop command is inputted is not being transferred to the normal recording area, the data transfer after the data to the recording point on the full-time recording area at the time point where the normal recording stop command is inputted is transferred to the normal recording area; and a fourth circuit for stopping, when the second circuit judges that the data to the recording point on the full-time recording area at the time point where the normal recording stop command is inputted is being transferred to the normal recording area, the data transfer.

The foregoing and other objects, features, aspects and advantages of the present invention will become more apparent from the following detailed description of the present invention when taken in conjunction with the accompanying drawings

### BRIEF DESCRIPTION OF THE DRAWINGS

FIG. 1 is a block diagram showing the schematic configuration of a recording and reproducing apparatus;

FIG. 2 is a schematic view for explaining an operation performed when a normal recording start command is inputted during full-time recording and time shift reproduction;

FIG. 3 is a flow chart showing the procedure for processing performed when a normal recording start command is inputted in a first embodiment;

FIG. 4 is a flow chart showing the procedure for processing performed when a normal recording start command is inputted in a second embodiment; and

FIG. 5 is a flow chart showing the detailed procedure for data transfer start position designation processing (processing in the step 26 shown in FIG. 4).

### DESCRIPTION OF THE PREFERRED EMBODIMENTS

Referring now to the drawings, embodiments of the present invention will be described.

[1] Description of First Embodiment

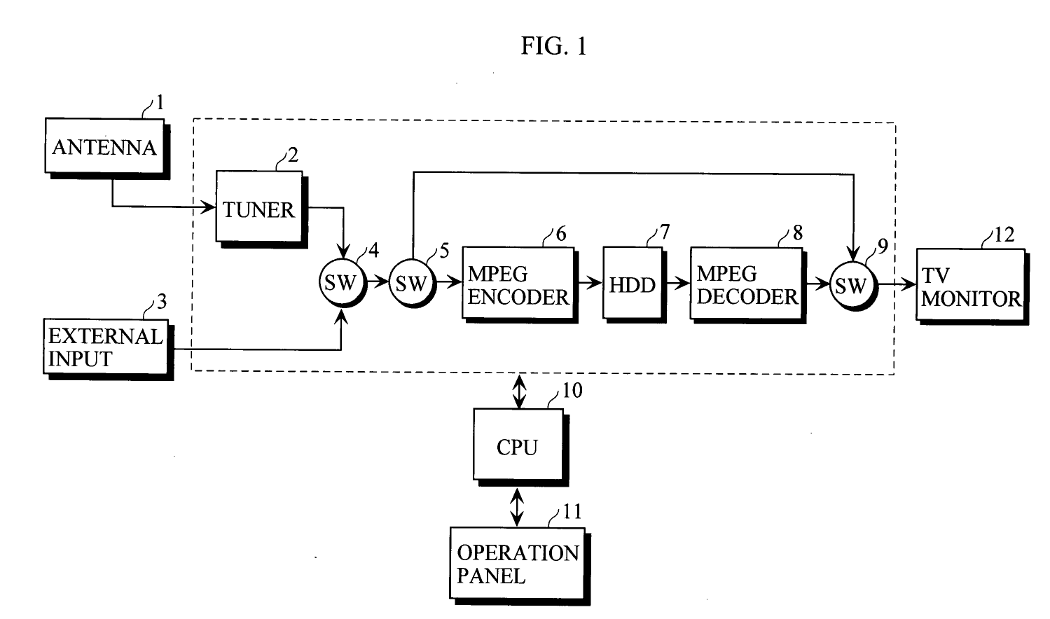

FIG. 1 illustrates the schematic configuration of a recording and reproducing apparatus.

The recording and reproducing apparatus comprises an antenna 1, a tuner 2, an external input terminal 3, a switch 4, a switch 5, an MPEG (Motion Picture Expert Group) encoder 6, an HDD (Hard Disk Drive) 7, an MPEG decoder 8, a switch 9, and a CPU 10, and an operation panel 11.

The switch 4 switches an input signal from the tuner 2 and an input signal from the external input terminal 3.

Examples of a switching mode of the switch 5 include a first switching mode for feeding an input signal to only the MPEG decoder 8 in order to record the input signal on the HDD 7, a second switching mode for feeding an input signal to only the switch 9 in order to output the input signal as it is (on the air) to a television monitor 12 without recording the input signal, and a third switching mode for feeding an input signal to both the switch 9 and the MPEG decoder 8.

The switch 9 selects a signal fed through the switch 5 or a signal fed from the MPEG decoder 8 and outputs the selected signal to the television monitor 12.

The MPEG encoder 6 encodes the input signal inputted through the switches 4 and 5, and data representing the input signal encoded by the MPEG encoder 6 is recorded on the HDD 7.

The MPEG encoder 8 decodes the data read out of the HDD 7, and a signal represented by the data decoded by the MPEG decoder 8 is outputted to the television monitor 12 through the switch 9.

The HDD 7 includes a full-time recording area where data is recorded at the time of full-time recording and a normal recording area where data for normal recording is recorded. The full-time recording area composes a ring buffer. When the full-time recording area is filled with data, the data are erased by being successively overwritten over by new data.

The recording and reproducing apparatus comprises the function of performing full-time recording using a full-time recording area in the HDD 7 and a time shift reproduction function for reproducing data recorded all the times from an address which is the same as or different from a recording address.

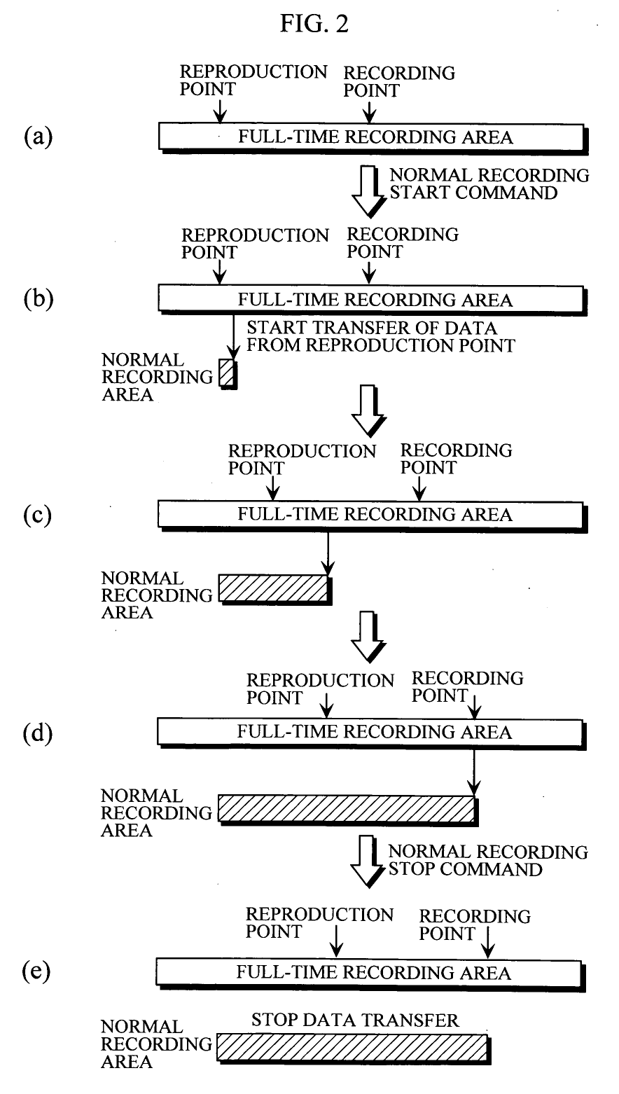

The recording and reproducing apparatus comprises the function of continuing, when the normal recording start command is inputted during full-time recording and time shift reproduction, the full-time recording operation as well as transferring to the normal recording area data from a time shift reproduction position, at the time that the normal recording start command is inputted, in the full-time recording area to a recording point on the full-time recording area at the time point where a normal recording stop command is inputted. The function will be described using FIG. 2.

It is assumed that full-time recording and time shift reproduction are being performed. FIG. 2 (a) illustrates a recording point and a reproduction point on a full-time recording area.

In this state, when a normal recording start command is inputted, a full-time recording operation and a time shift reproduction operation are continued as they are. As shown in FIG. 2 (b), transfer of data recorded on the full-time recording area from the reproduction point on the full-time recording area at the time point where the normal recording start command is inputted to a normal recording area is started.

Consequently, the data in the full-time recording area is transferred to the normal recording area, as shown in FIG. 2 (c). As shown in FIG. 2 (d), a position, where data is transferred (hereinafter referred to as a data transfer position) to the normal recording area, in the full-time recording area overtakes the current recording point on the full-time recording area. Thereafter, as the recording point moves, the data in the full-time recording area is transferred to the normal recording area.

When a normal recording stop command is inputted, the data transfer from the full-time recording area to the normal recording area is stopped. As shown in FIG. 2 (e), data in the full-time recording area from the reproduction point on the full-time recording area at the time point where the normal recording start command is inputted to the recording point on the full-time recording area at the time point where the normal recording stop command is inputted is transferred to the normal recording area.

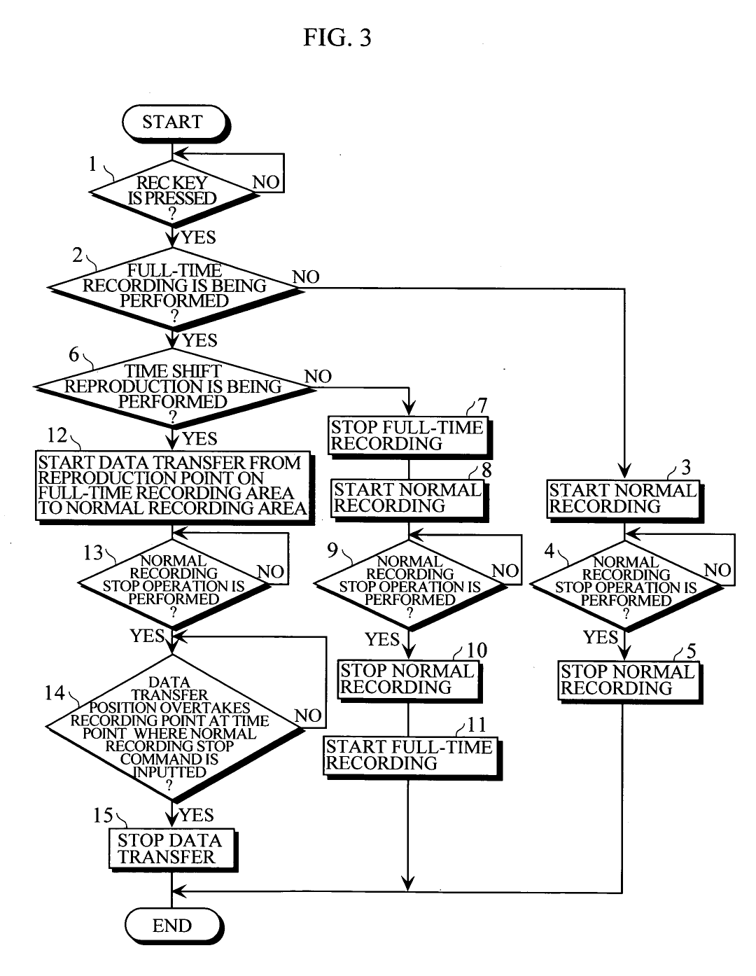

FIG. 3 shows the procedure for processing performed when a normal recording start command is inputted.

When an REC key is pressed, that is, the normal recording start command is inputted (step 1), it is judged whether or not full-time recording is being performed (step 2).

Unless the full-time recording is being performed, normal recording is started (step 3). That is, data encoded by the MPEG encoder 6 is recorded on a normal recording area. When a recording stop operation is performed (step 4), the normal recording is stopped (step 5).

When it is judged in the foregoing step 2 that the full-time recording is being performed, it is judged whether or not time shift reproduction is being performed (step 6). Unless the time shift reproduction is being performed, the full-time recording is stopped (step 7), and the normal recording is then started (step 8). That is, the data encoded by the MPEG encoder 6 is recorded on the normal recording area. When the recording stop operation is performed (step 9), the normal recording is stopped (step 10), and the full-time recording is then started (step 11).

When it is judged in the foregoing step 6 that the time shift reproduction is being performed, transfer (copying) of data in the full-time recording area from the current reproduction point on the full-time recording area (a time shift reproduction position) to the normal recording area is started (step 12). In this case, the full-time recording operation and the time shift reproduction operation are continued.

Thereafter, when a normal recording stop operation is performed (a normal recording stop command is inputted) (step 13), it is judged whether or not the data transfer position, to the normal recording area, in the full-time recording area overtakes a recording point at the time point where the normal recording stop command is inputted in the full-time recording area (step 14). When the data transfer position overtakes the recording point, the data transfer is stopped (step 15). Unless the data transfer position overtakes the recording point, the data transfer is not stopped until the data transfer position overtakes the recording point (step 14).

[2] Description of Second Embodiment

The configuration of a recording and reproducing apparatus is the same as that in the first embodiment.

The recording and reproducing apparatus according to the second embodiment comprises the function of performing full-time recording using a full-time recording area in an HDD 7 and a time shift reproduction function for reproducing data recorded all the times from an address which is the same as or different from a recording address.

The recording and reproducing apparatus comprises the function of continuing, when a normal recording start command is inputted during full-time recording, the full-time recording, and causing a user to designate a position where data transfer is started (hereinafter referred to as a data transfer start position), to transfer to a normal recording area data from the data transfer start position in a full-time recording area designated by the user to a recording point on the full-time recording area at the time point where a normal recording stop command is inputted.

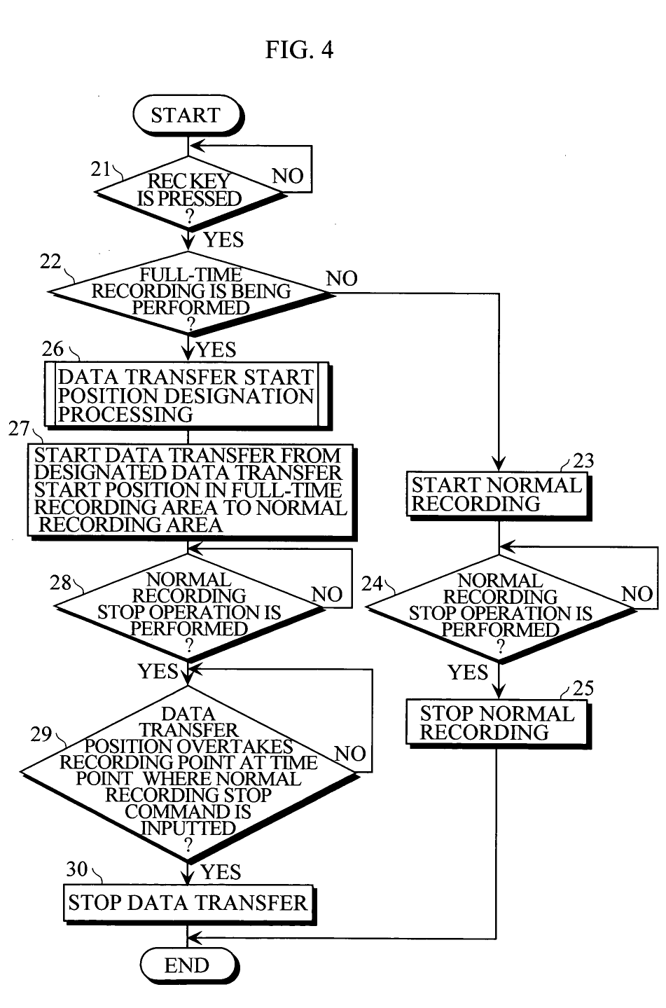

FIG. 4 shows the procedure for processing performed when a normal recording start command is inputted,

When an REC key is pressed, that is, the normal recording start command is inputted (step 21), it is judged whether or not full-time recording is being performed (step 22).

Unless the full-time recording is being performed, normal recording is started (step 23). That is, data encoded by an MPEG encoder 6 is recorded on a normal recording area. When a recording stop operation is performed (step 24), the normal recording is stopped (step 25).

When it is judged in the foregoing step 22 that the full-time recording is being performed, processing for causing a user to designate the data transfer start position (a position where normal recording is substantially started) from the full-time recording area to the normal recording area (data transfer start position designation processing) is performed (step 26). The processing is processing for designating the data transfer start position, i.e., some minutes before the recording point on the full-time recording area at the time point where the REC key is pressed. The details of the processing will be described later.

When the data transfer start position is designated by the data transfer start position designation processing, transfer (copying) from the designated data transfer start position in the full-time recording area to the normal recording area is started (step 27). In this case, a full-time recording operation is continued. When time shift reproduction is performed, a time shift reproduction operation is continued.

Thereafter, when a normal recording stop operation is performed (a normal recording stop command is inputted) (step 28), it is judged whether or not a data transfer position, to the normal recording area, in the full-time recording area overtakes a recording point in the full-time recording area at the time point where the normal recording stop command is inputted (step 29) When the data transfer position overtakes the recording point, the data transfer is stopped (step 30). Unless the data transfer position overtakes the recording point, the data transfer is not stopped until the data transfer position overtakes the recording point (step 29).

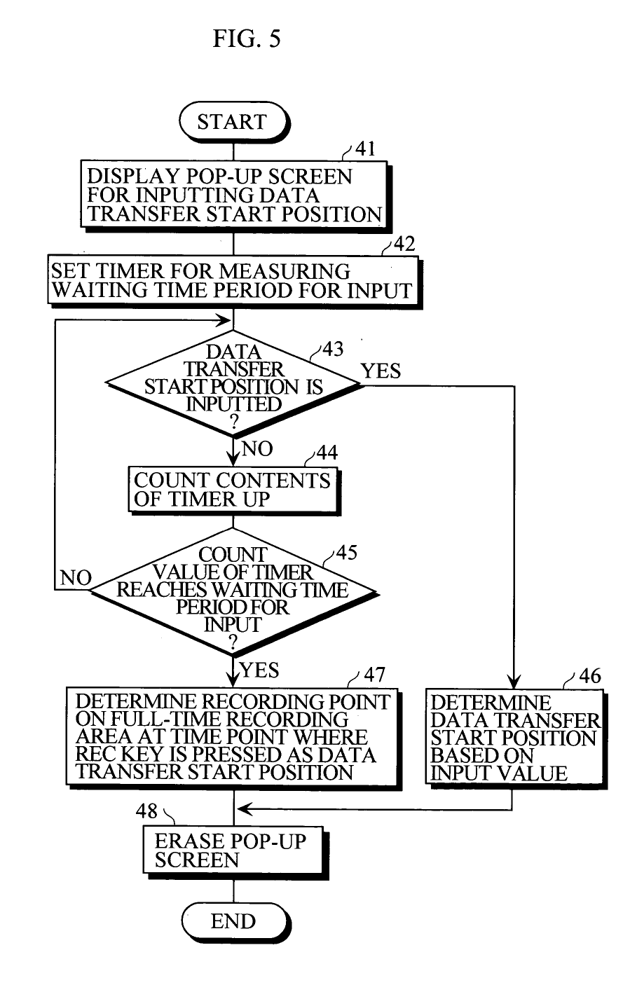

FIG. 5 is a flow chart showing the detailed procedure for the data transfer start position designation processing (the processing in the step 26 shown in FIG. 4).

First, a pop-up screen for inputting a data transfer start position is displayed (step 41). On the screen, a message “Please designate a data transfer start position by a ten-key”, for example, is displayed. A user uses a ten-key on the operation panel 11 to enter the data transfer start position, i.e., some minutes before the recording point on the full-time recording area at the time point where the REC key is pressed.

A timer for measuring a waiting time period for input of the data transfer start position is set (step 42).

It is then judged whether or not the data transfer start position is inputted (step 43). Unless the data transfer start position is inputted, the contents of the timer are counted up (step 44). It is judged whether or not a count value of the timer reaches a predetermined waiting time period for input (step 45). Unless the count value of the timer reaches the predetermined waiting time period for input, the procedure is returned to the step 43.

When it is judged in the foregoing step 43 that the data transfer start position is inputted, the data transfer start position is determined on the basis of its input value (step 46), and the pop-up screen displayed in the step 41 is then erased (step 48). The data transfer start position designation processing is terminated.

When it is judged in the foregoing step 45 that the count value of the timer reaches the predetermined waiting time period for input, the recording point on the full-time recording area at the time point where the REC key is pressed is determined as the data transfer start position (step 47), and the pop-up screen displayed in the step 41 is erased (step 48). The data transfer start position designation processing is terminated.

Although the present invention has been described and illustrated in detail, it is clearly understood that the same is by way of illustration and example only and is not to be taken by way of limitation, the spirit and scope of the present invention being limited only by the terms of the appended claims.

1. A recording and reproducing apparatus comprising:
first means for continuing, when a normal recording start command is inputted during full-time recording and time shift reproduction, the full-time recording as well as starting data transfer from a time shift reproduction position, at the time that the normal recording start command is inputted, in a full-time recording area to a normal recording area;
second means for judging, when a normal recording stop command is inputted in a case where the transfer by the first means is being performed, whether or not data to a recording point on the full-time recording area at the time point where the normal recording stop command is inputted is being transferred to the normal recording area;
third means for stopping, when the second means judges that the data to the recording point on the full-time recording area at the time point where the normal recording stop command is inputted is not being transferred to the normal recording area, the data transfer after the data to the recording point on the full-time recording area at the time point where the normal recording stop command is inputted is transferred to the normal recording area; and
fourth means for stopping, when the second means judges that the data to the recording point on the full-time recording area at the time point where the normal recording stop command is inputted is being transferred to the normal recording area, the data transfer.

2. A recording and reproducing apparatus comprising:
a first circuit for starting, when a normal recording start command is inputted during full-time recording and time shift reproduction, the full-time recording as well as starting data transfer from a time shift reproduction position, at the time that the normal recording start command is inputted, in a full-time recording area to a normal recording area;
a second circuit for judging, when a normal recording stop command is inputted in a case where the transfer by the first circuit is being performed, whether or not data to a recording point on the full-time recording area at the time point where the normal recording stop command is inputted is being transferred to the normal recording area;
a third circuit for stopping, when the second circuit judges that the data to the recording point on the full-time recording area at the time point where the normal recording stop command is inputted is not being transferred to the normal recording area, the data transfer after the data to the recording point on the full-time recording area at the time point where the normal recording stop command is inputted is transferred to the normal recording area; and
a fourth circuit for stopping, when the second circuit judges that the data to the recording point on the full-time recording area at the time point where the normal recording stop command is inputted is being transferred to the normal recording area, the data transfer.

3. A recording and reproducing apparatus comprising:
input means for continuing, when a normal recording start command is inputted during full-time recording, the full-time recording as well as designating a data transfer start position in a full-time recording area;
first means for starting data transfer from the data transfer start position in the full-time recording area designated by the input means to a normal recording area;
second means for judging, when a normal recording stop command is inputted in a case where the transfer by the first means is being performed, whether or not data to a recording point on the full-time recording area at the time point where the normal recording stop command is inputted is being transferred to the normal recording area;
third means for stopping, when the second means judges that the data to the recording point on the full-time recording area at the time point where the normal recording stop command is inputted is not being transferred to the normal recording area, the data transfer after the data to the recording point on the full-time recording area at the time point where the normal recording stop command is inputted is transferred to the normal recording area; and
fourth means for stopping, when the second means judges that the data to the recording point on the full-time recording area at the time point where the normal recording stop command is inputted is being transferred to the normal recording area, the data transfer.

4. A recording and reproducing apparatus comprising:
an input circuit for continuing, when a normal recording start command is inputted during full-time recording, the full-time recording as well as designating a data transfer start position in a full-time recording area;
a first circuit for starting data transfer from the data transfer start position in the full-time recording area designated by the input circuit to a normal recording area;
a second circuit for judging, when a normal recording stop command is inputted in a case where the transfer by the first circuit is being performed, whether or not data to a recording point on the full-time recording area at the time point where the normal recording stop command is inputted is being transferred to the normal recording area;
a third circuit for stopping, when the second circuit judges that the data to the recording point on the full-time recording area at the time point where the normal recording stop command is inputted is not being transferred to the normal recording area, the data transfer after the data to the recording point on the full-time recording area at the time point where the normal recording stop command is inputted is transferred to the normal recording area; and
a fourth circuit for stopping, when the second circuit judges that the data to the recording point on the full-time recording area at the time point where the normal recording stop command is inputted is being transferred to the normal recording area, the data transfer.
